(19) United States
(12) Patent Application Publication
(10) Pub. No.: US 2006/0218970 A1
(43) Pub. Date: Oct. 5, 2006

(54) Silicon oxide based articles

(75) Inventors: Giulio Boara, Crema (IT); Simone Pedretti, Oleggio (IT); Andreas Rückemann, Oleggio (IT); Massimo Sparpaglione, S. Donato Milanese (IT)

Correspondence Address: FITCH, EVEN, TABIN & FLANNERY, P. O. BOX 65973, WASHINGTON, DC, 20035, US

(73) Assignee: Degussa Novara Technology S.p.A, Novara (IT)

(21) Appl. No.: 10/549,681

(22) PCT Filed: Mar. 12, 2004
(86) PCT No.: PCT/EP04/02578

§ 371 Date: Sep. 19, 2005

(30) Foreign Application Priority Data
Mar. 21, 2003 (IT) NO 2003A000006

(51) Int. Cl. C03B 37/016; C03B 8/00; B29B 7/00; C04B 35/03

(52) U.S. Cl. 65/17.2; 65/395; 501/94; 428/542.8

(57) ABSTRACT

Particularly shaped articles constituted by silicon oxide, as such or with suitable additives, prepared by room temperature molding according to a process comprising: preparation of a sol starting from a silicon alcoxide, or from a silicon alcoxide and at least a precursor of at least one of the additional elements; hydrolysis of the sol obtained thereby; addition of colloidal silica; pouring the resulting mixture into the desired mould; sol gelling and fast removal of the solid product; gel drying; gel densification by means of a thermal treatment at temperature ranging from 900 ° C to 1500 ° C. The articles can be used as preforms for the optic fiber spinning.

The present invention relates to articles, characterized by particular shapes, constituted by silicon oxide as such or suitably added, and obtained by molding at room temperature through sol-gel procedures. Particularly the present invention relates to articles having a shape which is obtained by means of suitable moulds employed within the route of a sol-gel procedure and selected on the ground of the aimed final use, such a shape allowing the same to be utilized in many fields: of particular interest is the preparation of preforms cut out for optical fiber spinning.

The sol-gel term defines a wide variety of processes which, even being different as for as the working details or the reagents are concerned, are characterized by the following common operations:
preparation of a solution, or a suspension, of a precursor formed by a compound of the element (M) the oxide of which has to constitute the final glassy article;
hydrolysis, acid or base catalyzed, of the precursor, inside the solution or suspension, to form M-OH groups according to the reaction
   MXₙ+nH₂O→M(OH)ₙ+nHX
   wherein X generally is an alcohol residue and n means the element M valence; the alcoxydes M(OR)n can be replaced by soluble salts of the element X such as chlorides or nitrates, and, in some cases, oxyides. The obtained mixture, i.e. a solution or a colloidal suspension, is named sol;
polycondensazion of the M-OH groups according to the reaction
   M-OH+M-OH→M-O-M+H₂O
   which requires a time from few seconds to some days, depending on the solution composition and-the temperature; during the step, a matrix is formed called, case by case, alcohogel, hydrogel or more generally, gel;
gel drying till the formation of a porous monolithic body; during this step, the solvent is removed through a simple controlled evaporation, which determines the so called xerogel, or through an extraction in autoclave which determines the so called aerogel; the obtained body is a porous glass, which may have an apparent density of 10% to about 50% of the theoric density of the oxide with the same composition; the dried gel can be industrially used as such;
densification of the dried gel by a treatment at a temperature, generally ranging between 800° C. and 1500° C., depending on the gel chemical composition and the preceding step process parameters; during this step the porous gel is becoming dense up to obtain a glassy or ceramic compact oxide having the theoric density, with a linear shrinkage equal to about 50%.

According to the above said 1a procedure, it is possible to prepare monoliths of the interesting material by pouring sol onto a suitable mould, or films too by pouring sol onto a suitable substrate, or preforms of optical fibers too.

With specific reference to these latter, it is,known that such fibers, largely employed in the telecommunication field, are constituted by a central portion, the so called “core”, and by a couting around the core, generally named “mantle”. A difference ranging about from 0.1% to 1% tbetween the core and the mantle refraction indexes let light be confined in the core. Such a difference in the refraction index is obtained through different chemical composition of the core and the mantle.

Even if many combinations are evaluated, the most common is constituted by a glassy core formed by silicon oxide doped by germanium oxide (GeO₂—SiO₂) surrounded by a glassy SiO₂ mantle. The widest used optical fibers are of the monomodal kind, being characterized by one only allowed optical path. Such fibers generally owns a core with a 4-8 μm diameter and a mantle external diameter of 125 μm.

The most important parameter to evaluate the quality of a fiber is the relevant optical fading out, which is mainly due to light absorbing and diffusion mechanisms and is measured in decibel for kilometer (dB/Km).

As the skilled people know, UV fading out is mainly due to the absorption by the cations (as the transition metal cations) present in the fiber core, while the IR fading out is mainly due to the absorption by —OH groups which may be in the glass. The fading out of light having an intermediate wave length between UV and IR is mainly due to diffusion phenomena caused by fluctuations of the refraction indexes because of the glass unhomogeneity, of the fiber structure defects, such as imperfections in the core-mantle contact surface, fiber bubbles or breaks, or impurities inglobed within the fiber during the production process.

The optical fiber are prepared by bringing a preform to temperatures of about 2200° C. The preform is an intermediate in the fiber production, formed by an internal rod and an external coat corresponding to core and mantle of the final fiber. The ratio between the coating and rod diameters is equal to the one between the mantle and the core diameters in the finale fiber. Hereinafter, the words rod and core will be respectively used with reference to the inner part of the preform and the final fiber, while the word mantle will be used to indicate the external part either of the preforms or of the fibers.

It is known that the mantle of the preforms for the commercially available optical fibers is produced according to modifications of the ground chemical deposition process from the vapor phase (better known as “Chemical Vapor Deposition” or the acronyme “CVD”). All processes deriving from CVD make generally use of gaseous mixtures comprising oxygen (O₂) and silicon chloride (SiCl₄) or germanium chloride (GeCl₄) into an oxy-hydrogen flame to produce SiO₂ and GeO₂ according to the reactions:
SiCl₄(g)+O₂(g)→SiO₂(s)+2Cl₂(g) (I)
GeCl₄(g)+O₂(g)→GeO₂(s)+2Cl₂(g) (II)

The oxydes produced thereby can be deposited as particles onto a cylinder carrier which is then removed or, as an alternative, onto the inner surface of a silica cylinder carrier which is then processed to form the mantle of the final fiber.

The CVD based processes are suitable to produce optical fiber with 0.2 dB/Km minimum fading out (for transmitted light with 1.55 μm wave length), and are the state of the art in the field.

Even if these producing methods are quite satisfactory as to the performance of the resulting fibers, the yields are limited thus increasing the production costs.

It is also well known that, during the thermal treatments to achieve the complete densification of the dry gel, it is possible to carry out chemical purification thereof. Through such treatments it is possible to take advantage from the dry gel porosity to carry out washing operations in the gaseous phase in order to remove organic impurities caused to be present in the gel because of the organometallic precursors (as the previous mentioned TMOS and TEOS), as well as water, hydroxul groups linked to the cations in the gel network, or undesired metal atoms.

Generally, the removal of organic impurities is obtained through a calcination carried out by flowing an oxidizing atmosphere (oxygen or air) into the dry gel at temperatures lower than 900° C., particularly between 350° C. and 800° C.

The removal of water, hydroxyl groups and undesired metals is carried out by letting the gel pores be flowed by Cl₂, HCl or CCl₄, eventually mixtures with inert gases as nitrogen or helium, at temperatures between about 400° C. and 800° C.

The last operation is usually a washing treatment, carried out with inert gases like nitrogen, helium or argon, to totally remove chlorine or chlorine containing gases from the gel pores. At the end of these treatments, gel is densified to the corresponding glass, totally dense (hereinafter such state will be designated also as “theoric density”) by heating at temperatures higher than 900° C., and usually higher than 1200° C., under a helium environment.

The above described treatments are quite suitable to purify gels so that the resulting glasses are suitable to be largely used (generally to build optical or mechanical parts). However, it has been found that these treatments cause the presence of gaseous compounds in the final glass. In case of processing the same in the temperature range of 1900 to 2200° C. in order to draw the fibers, those gaseous compound traces give rise to microscopic bubbles which become fracture starting points, thus causing the fiber to break and the known processes to be not suitable to produce optical fibers.

The present invention allows the preparation of preforms suitable to spin optical fibers without the above said drawbacks, such fibers having characteristics equal to and sometimes higher than the ones achievable by means of the CVD technology. Moreover, the present invention relates to, according to a broad meaning, the preparation of articles having the shape desired in relation with the final use, constituted by silicon oxide, as such as suitably additivated, and comprising the above said optical fibers preforms and, furtherly, liquid safety containers, transparent (and not) devices to be used in the chemical laboratories, vessels, and, more generally, vitreous products appointed at furnishing too.

Therefore, the present invention refers to particularly shaped articles constituted by silicon oxide, as such or suitably additivated, prepared by molding at room temperature according to the process comprising the following operations:
preparation of a sol starting from a silicon alcoxide, or from a silicon alcoxide and at least a precusor of at least one of the additional elements;
hydrolysis of the sol obtained thereby;
addition of colloidal silica;
pouring the resulting mixture into the desired mould;
sol gelling and fast removal of the solid product;
gel drying;
gel densification by means of a thermal treatment at temperature ranging from 900° C. to 1500° C.

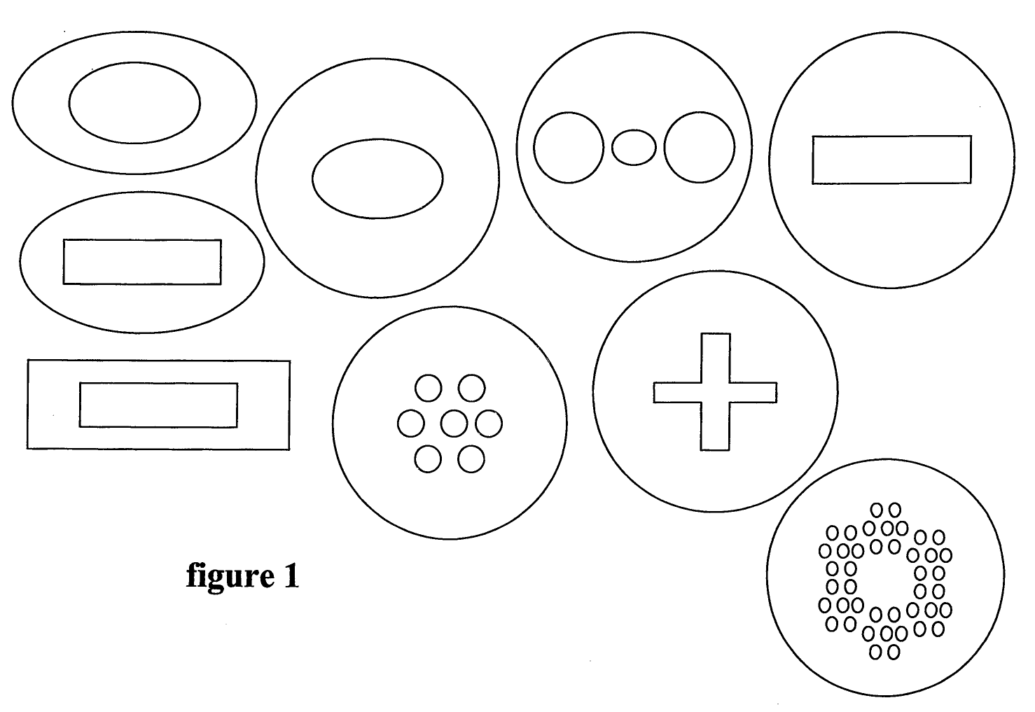

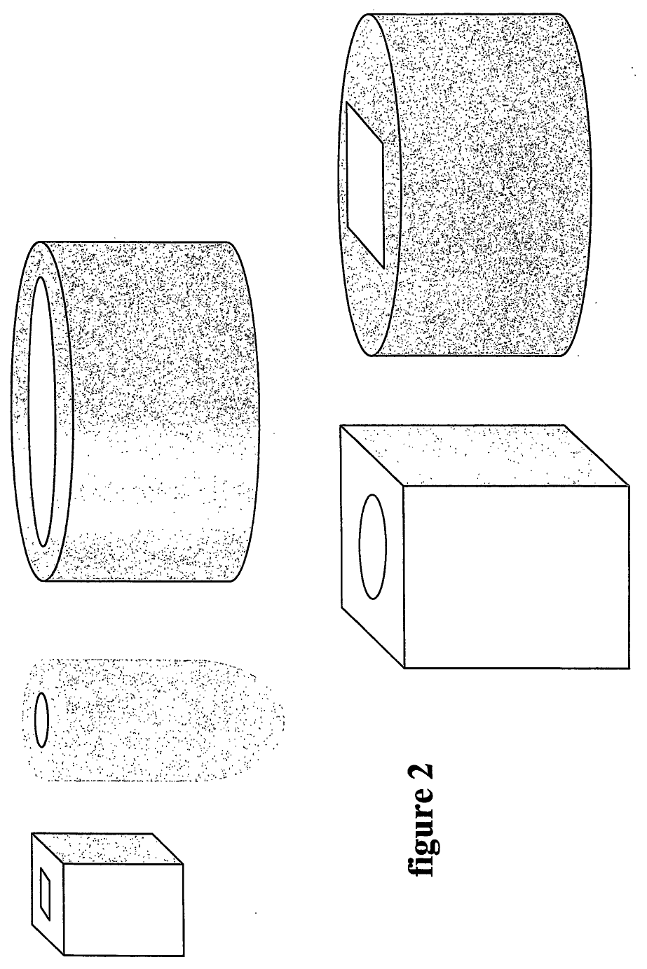

Preferred silicon alcoxides are tetramethylortosilicate and tetraethylortosilicate. When one or more additives are to be added, the same are selected by the people skilled in the art dependently upon the final purposes, the preferred one being chosen among the elements of the IIIa, IVa, Va, IIIb, IVb, Vb Groups of the Periodic Table. Even the mould will be selected by the people skilled in the art, again dependently upon the aimed use of the final article. Illustrative examples of the present invention, no way limiting the same, are the sections reported in FIG. 1 as to the optical fiber preforms, and in FIG. 2 as to some other possible employment.

In the above mentioned sol-gel procedure, all operations till the very molding are carried out at room temperature; the gel drying can be performed under ipercritical or subcritical conditions.

1-4. (canceled)

5. A process for making a shaped article of silicon oxide, comprising:
a) preparing a sol from a silicon alcoxide;
b) allowing or inducing the hydrolysis of the sol prepared in step a);
c) adding colloidal silica to the sol that has undergone hydrolysis according to step b) to form a sol mixture;
d) pouring the sol mixture of step c) into a mould;
e) allowing the sol mixture in said mould to form a gel and then removing it from said mould;
f) drying the gel obtained in step e); and
g) thermally treating the gel dried in step f) at a temperature of 900° C.-1500° C. to increase its density.

6. The process of claim 5, wherein steps a) to e) are carried out at room temperature.

7. The process of claim 5, wherein the hydrolysis of step b) is induced using an acid or base catalyst.

8. The process of claim 5, wherein said silicon alcoxide of step a) is either tetramethylortosilicate or tetraethylortosilicate.

9. The process of claim 5, wherein the sol formed in step a) further comprises at least one element selected from group IIIa, IVa, Va, IIIb or Vb of the periodic table.

10. The process of claim 9, wherein said element is germanium.

11. The process of claim 10, wherein said germanium is in the form of a chloride salt.

12. A shaped article made by the process of claim 5.

13. The shaped article of claim 12, wherein said article is a preform that can be used to make optical fibers.

14. The shaped article of claim 12, wherein said article has a shape selected from the shapes shown in FIG. 1.

15. The shaped article of claim 12, wherein said article has a shape selected from the shapes shown in FIG. 2.

16. A shaped article made by the process of claim 9.

17. The shaped article of claim 16, wherein said article is a preform that can be used to make optical fibers.

18. The shaped article of claim 16, wherein said article has a shape selected from the shapes shown in FIG. 1.

19. The shaped article of claim 16, wherein said article has a shape selected from the shapes shown in FIG. 2.

20. A shaped article made by the process of claim 10.

21. The shaped article of claim 10, wherein said article is a preform that can be used to make optical fibers.

22. An optical fiber made from the preform of claim 21.

23. The shaped article of claim 20, wherein said article has a shape selected from the shapes shown in FIG. 1.

24. The shaped article of claim 20, wherein said article has a shape selected from the shapes shown in FIG. 2.
